(19) United States
(12) Patent Application Publication
(10) Pub. No.: US 2016/0241797 A1
(43) Pub. Date: Aug. 18, 2016

(54) DEVICES, SYSTEMS, AND METHODS FOR SINGLE-SHOT HIGH-RESOLUTION MULTISPECTRAL IMAGE ACQUISITION

(71) Applicant: CANON KABUSHIKI KAISHA, Tokyo (JP)

(72) Inventor: Jinwei Ye, San Jose, CA (US)

(21) Appl. No.: 14/962,486

(22) Filed: Dec. 8, 2015

Related U.S. Application Data
(60) Provisional application No. 62/117,367, filed on Feb. 17, 2015.

(51) Int. Cl. H04N 5/335

(52) U.S. Cl. CPC H04N 5/335

(57) ABSTRACT

Systems, methods, and devices for generating high-resolution multispectral light-field images are described. The systems and devices a main lens include a microlens array, a multispectral-filter array that comprises spectral filters that filter light in different wavelengths, and a sensor that is configured to detect incident light. Also, the main lens, the microlens array, the multispectral-filter array, and the light sensor are disposed such that light from a scene passes through the main lens, the microlens array, and the multispectral-filter array and strikes a sensing surface of the sensor. Additionally, the multispectral-filter array is disposed so as to encode, in the light that strikes the sensing surface, a plane of the microlens array on the sensing surface of the sensor. Furthermore, the systems, methods, and devices generate high-resolution multispectral light field-images from low-resolution sub-aperture images using an optimization framework that uses a first order gradient sparsity in intensity and a second order gradient sparsity in wavelength as regularization terms.

### CROSS-REFERENCE TO RELATED APPLICATIONS

This application claims the benefit of U.S. Provisional Application No. 62/117,367, which was filed on Feb. 17, 2015 and which is hereby incorporated by reference.

### BACKGROUND

1. Technical Field

This description generally relates to high-resolution multispectral light-field imaging.

2. Background

A multispectral image of a scene includes an array of images that sample the scene at different wavelengths or spectral bands. To acquire a multispectral image, a conventional monochrome camera must capture multiple shots of the scene, because only one spectral band can be captured in each shot. For example, some cameras have a liquid-crystal tunable filter that is placed in front of the camera lens and that is tuned to filter the wavelength of light entering the camera. To capture a multispectral image of n wavelengths, n spectral filters need to be applied while capturing images. Therefore, n shots are required.

Light-field cameras enable multi-view imaging in a single shot. Light-field cameras include a microlens array that is mounted in front of the camera sensor. The microlens array spreads light rays onto different locations on the camera sensor, resulting in angularly sampled images. After sampling the light-field rays, an array of images with viewpoint variations can be synthesized. The measurement of angularly-sampled light-field rays is made possible by trading the spatial resolution of the sensor for angular resolution. Consequently, given the same sensor size, the resolution of a light-field camera is lower than the resolution of a conventional camera.

### SUMMARY

In some embodiments, a system comprises a light-field camera that mounts a multispectral-filter array on the microlens plane for capturing multispectral light-field images and a computing device that implements a wavelength-domain super-resolution algorithm that generates high-resolution multispectral light-field images.

In some embodiments, a multispectral light-field camera comprises a main lens, a microlens array, a multispectral-filter array, and an image sensor. The microlens array is disposed on the focal plane of the main lens, and the multispectral-filter array coincides with the microlens array. Also, the image sensor is disposed on the focal plane of the microlens array.

In some embodiments, a method for generating high-resolution multispectral images estimates the high-resolution images in one spectral band using sub-pixel shifts in light-field images, interpolates high-resolution images in one spectral band based on the sparsity of a first-order intensity gradient, interpolates high-resolution images across the spectral bands based on the sparsity of a second-order spectral gradient, and generates the final high-resolution multispectral light-field images by performing an optimization process.

In some embodiments, a system comprises a main lens, a microlens array, a multispectral-filter array that comprises spectral filters that filter light in different wavelengths, and a sensor that is configured to detect incident light. Also, the main lens, the microlens array, the multispectral-filter array, and the light sensor are disposed such that light from a scene passes through the main lens, the microlens array, and the multispectral-filter array and strikes a sensing surface of the sensor. Furthermore, the multispectral-filter array is disposed so as to encode, in the light that strikes the sensing surface, a plane of the microlens array on the sensing surface of the sensor.

In some embodiments, a system comprises one or more computer-readable storage media and comprises one or more processors that are coupled to the one or more computer-readable storage media and that are configured to cause the system to obtain a multispectral image that is composed of microlens images and generate sub-aperture images from the microlens images. Each sub-aperture image includes a pixel from each microlens image. Also, each microlens image was captured by a respective microlens-image area of a sensor, and each microlens image was generated based on light that passed through a main lens, a respective microlens of a microlens array, and a respective spectral filter of a multispectral-filter array and that was detected by the respective microlens-image area of the sensor.

In some embodiments, one or more non-transitory computer-readable media store instructions that, when executed by one or more computing devices, cause the one or more computing devices to perform operations comprising obtaining sub-aperture images and generating a high-resolution multispectral image from the sub-aperture images based on the sub-aperture images and on a sparsity prior in second-order gradients of spectral images in a wavelength domain.

### BRIEF DESCRIPTION OF THE DRAWINGS

FIG. 1 illustrates an example embodiment of a system for single-shot high-resolution multispectral light-field image acquisition.

FIG. 2 illustrates example embodiments of systems for single-shot high-resolution multispectral light-field image acquisition.

FIG. 3A illustrates an example embodiment of a configuration of a main lens, a microlens array, a multispectral-filter array, and a sensor.

FIG. 3B illustrates an example embodiment of a configuration of a main lens, a microlens array, a multispectral-filter array, and a sensor.

FIG. 3C illustrates an example embodiment of a configuration of a main lens, a microlens array, a multispectral-filter array, and a sensor.

FIG. 3D illustrates an example embodiment of a configuration of a main lens, a microlens array, a multispectral-filter array, and a sensor.

FIG. 4 illustrates an example embodiment of a configuration of a main lens, a microlens array, a multispectral-filter array, and a sensor.

FIG. 5A illustrates an example embodiment of a microlens array, a multispectral-filter array, and a sensor.

FIG. 5B illustrates an example embodiment of a microlens array, a multispectral-filter array, and a sensor.

FIG. 5C illustrates an example embodiment of a microlens array, a multispectral-filter array, and a sensor.

FIG. 6 illustrates example embodiments of a sensor, microlens images, and sub-aperture images.

FIG. 7A illustrates an example embodiment of an object, a main lens, a microlens array, a multispectral-filter array, and a sensor.

FIG. 7B illustrates an example embodiment of an object, a main lens, a microlens array, a multispectral-filter array, and a sensor.

FIG. 8 illustrates example embodiments of a sensor, microlens images, and an array of sub-aperture images.

FIG. 9 illustrates an example embodiment of image formation from multispectral sub-aperture images.

FIG. 10 illustrates example embodiments of a multispectral image, the wavelength responses of four pixels in the multispectral image, and the histograms of the second-order gradients of the four pixels.

FIG. 11 illustrates example embodiments of first-order gradients in the spatial domain and second-order gradients in the wavelength domain.

FIG. 12 illustrates an example embodiment of an operational flow for image reconstruction.

FIG. 13 illustrates an example embodiment of an operational flow for image reconstruction.

FIG. 14 illustrates an example embodiment of a high-resolution multispectral image.

FIG. 15 illustrates an example embodiment of a system for single-shot high-resolution multispectral image acquisition.

### DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

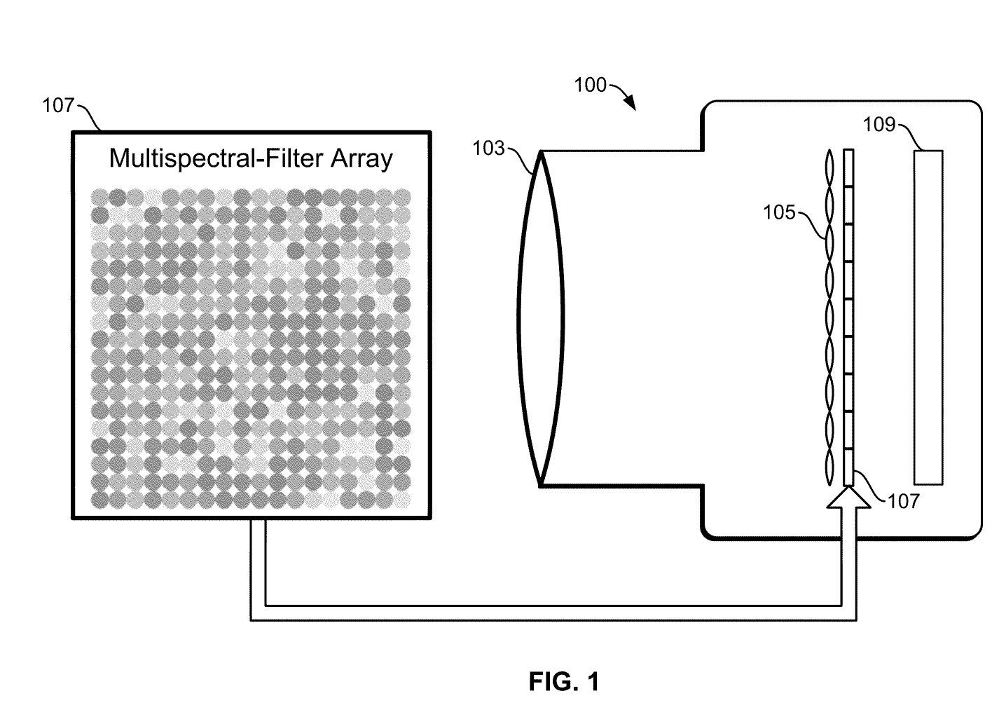

FIG. 1 illustrates an example embodiment of a system for single-shot high-resolution multispectral light-field image acquisition. The system 100 includes a main lens 103, a microlens array 105, a multispectral-filter array 107, and a sensor 109. The system 100 encodes the plane of the microlens array 105, instead of the plane of the main lens 103, and uses a reconstruction algorithm to recover high-resolution (both spatial and spectral) multispectral images from a single shot.

In this embodiment, the multispectral-filter array 107 is located between the microlens array 105 and the sensor 109. Thus, relative to the main lens 103, the multispectral-filter array 107 is behind the microlens array 105. In some embodiments, the multispectral-filter array 107 is integrated into the microlens array 105, for example by means of color-coating techniques. In some embodiments, the multispectral-filter array 107 is implemented on a separate layer and is attached to the microlens array 105. The multispectral-filter array 107 includes spectral filters, and the spectral filters may include one or more reconfigurable spectral filters. For example, in some embodiments, the multispectral-filter array 107 is composed of randomly distributed spectral filters that range from 410 nm to 700 nm (visible spectrum) with steps of 10 nm, for a total of thirty spectral bands. Also, in some embodiments, each microlens in the microlens array 105 is aligned with one respective spectral filter in the multispectral-filter array 107. Therefore, in some embodiments, the number of spectral filters in the multispectral-filter array 107 is the same as the number of microlenses in the microlens array 105.

The sensor 109 converts detected electromagnetic radiation (e.g., visible light, X-rays, infrared radiation) into electrical signals. For example, the sensor 109 can be a charge-coupled device (CCD) sensor or an active-pixel sensor (e.g., back-illuminated CMOS), and the sensor 109 can be a spectrally-tunable sensor. Also, in some embodiments, the sensor 109 does not include an additional color filter. For example, the sensor 109 may be a monochrome sensor that does not include a Bayer mask.

The system 100 can capture multispectral images of a scene in a single shot. Multispectral images of a scene refer to an array of images that sample the scene at different wavelengths or spectral bands. In contrast to the system 100, for a conventional monochrome camera to acquire multispectral images, the conventional monochrome camera needs to capture multiple shots because only one spectral band can be captured at a time.

When sampling multiple spectral bands using a basic light-field camera, several techniques can be used to encode the main lens of the basic light-field camera. Some techniques place a spectral-filter array on the aperture plane of the main lens. Light from a scene point enters the aperture at different locations, and, therefore, passes through different spectral filters. The microlens array makes an image of the aperture plane of the main lens on the sensor plane, thus producing an image that samples multiple spectral bands of the scene. However, such techniques trade the spatial resolution of the camera sensor for the spectral information, resulting in lower spatial resolution. Furthermore, due to the limited size of the microlens images, their spectral resolution is also very low.

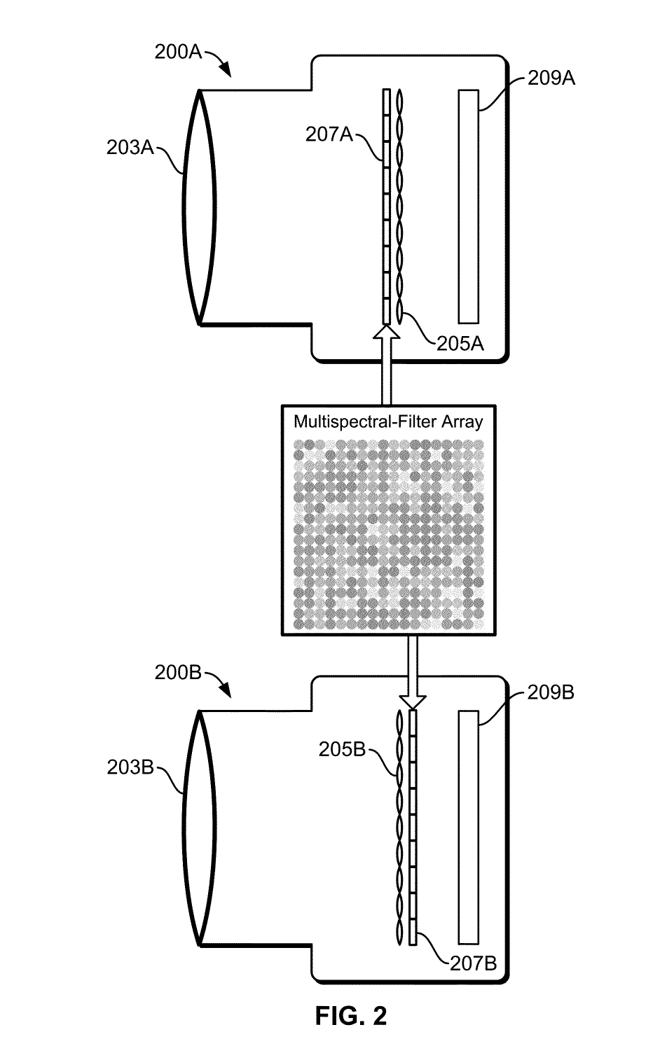

FIG. 2 illustrates example embodiments of systems for single-shot high-resolution multispectral image acquisition. A first system 200A includes a main lens 203A, a multispectral-filter array 207A, a microlens array 205A, and a sensor 209A. In the first system 200A, the multispectral-filter array 207A is disposed between the main lens 203A and the microlens array 205A. The main lens 203A, the multispectral-filter array 207A, the microlens array 205A, and the sensor 209A may be configured to prevent the rays that pass through a spectral filter of the multispectral-filter array 207A from passing through any microlens in the microlens array 205A that is not the microlens that corresponds to the spectral filter and reaching the sensor 209A. Thus, the rays that pass through a spectral filter and reach the sensor 209A pass through only the microlens that corresponds to the spectral filter. Furthermore, the rays that pass through a corresponding microlens and spectral filter strike only a corresponding microlens-image area on the sensor 209A. Therefore, the main lens 203A, the multispectral-filter array 207A, the microlens array 205A, and the sensor 209A may be positioned such that, of the rays that reach the sensor 209A, the rays that pass through a microlens and the corresponding spectral filter do not overlap with rays that pass through other microlenses and their corresponding spectral filters before the rays reach the sensor 209A.

A second system 200B includes a main lens 203B, a microlens array 205B, a multispectral-filter array 207B, and a sensor 209B. In the second system 200B, the multispectral-filter array 207B is disposed between the microlens array 205B and the sensor 209B. The main lens 203B, the microlens array 205B, the multispectral-filter array 2076, and the sensor 209B may be configured to prevent the rays that pass through a microlens of the microlens array 205B from passing through any filter in the multispectral-filter array 207B that is not the filter that corresponds to the microlens and reaching the sensor 209B. Thus, the rays that pass through a microlens and reach the sensor 209B pass through only the filter that corresponds to the microlens. Furthermore, the rays that pass through a corresponding microlens and spectral filter strike only a corresponding microlens-image area on the sensor 209B. Therefore, the main lens 203B, the microlens array 205B, the multispectral-filter array 207B, and the sensor 209B may be positioned such that, of the rays that reach the sensor 2096, the rays that pass through a microlens and the corresponding spectral filter do not overlap with rays that pass through other microlenses and their corresponding spectral filters before the rays reach the sensor 209B.

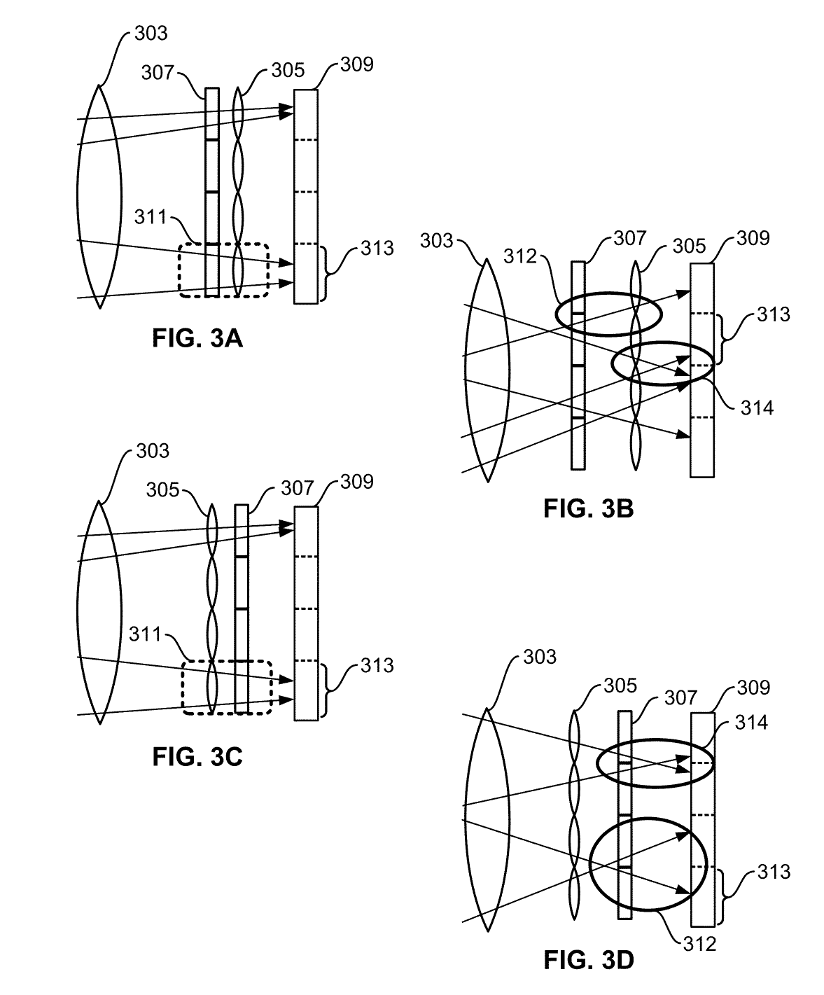

FIG. 3A illustrates an example embodiment of a configuration of a main lens 303, a multispectral-filter array 307, a microlens array 305, and a sensor 309. In this configuration, the multispectral-filter array 307 is positioned between the microlens array 305 and the main lens 303. The main lens 303, the multispectral-filter array 307, the microlens array 305, and the sensor 309 are configured so that a ray that strikes the sensing surface of the sensor 309 must have passed through a corresponding spectral filter and microlens, for example a first corresponding spectral filter and microlens 311. Furthermore, a ray that has passed through a corresponding spectral filter and microlens (e.g., the first corresponding spectral filter and microlens 311) will also strike the corresponding microlens-image area 313 on the sensor 309. Thus, this configuration prevents photon energy from being received by an undesired pixel of the sensor 309. Also, between the multispectral-filter array 307 and the sensor 309, rays that pass through a corresponding spectral filter and microlens will not overlap with rays that pass through another corresponding spectral filter and microlens.

FIG. 3B illustrates an example embodiment of a configuration of a main lens 303, a multispectral-filter array 307, a microlens array 305, and a sensor 309. In contrast to FIG. 3A, in this configuration a ray that strikes the sensing surface of the sensor 309 may have passed through a corresponding spectral filter and microlens, but may also have passed through a spectral filter and a microlens that do not correspond to each other. Such a ray is shown in a first highlighted area 312. Also, a ray that passes through a corresponding spectral filter and microlens to strike the sensing surface of the sensor 309 may not strike the microlens-image area 313 that corresponds to the corresponding spectral filter and microlens. Two such rays are shown in a second highlighted area 314. Thus, between the multispectral-filter array 307 and the sensor 309, rays that pass through a corresponding spectral filter and microlens may overlap with rays that pass through another corresponding spectral filter and microlens.

FIG. 3C illustrates an example embodiment of a configuration of a main lens 303, a microlens array 305, a multispectral-filter array 307, and a sensor 309. In this configuration, the multispectral-filter array 307 is positioned between the microlens array 305 and the sensor 309. The main lens 303, the microlens array 305, the multispectral-filter array 307, and the sensor 309 are configured so that a ray that strikes the sensing surface of the sensor 309 must have passed through a corresponding spectral filter and microlens, for example a first corresponding spectral filter and microlens 311. Additionally, a ray that has passed through a corresponding spectral filter and microlens (e.g., the first corresponding spectral filter and microlens 311) will also strike the corresponding microlens-image area 313 on the sensor 309.

FIG. 3D illustrates an example embodiment of a configuration of a main lens 303, a microlens array 305, a multispectral-filter array 307, and a sensor 309. In contrast to FIG. 3C, in this configuration a ray that strikes the sensing surface of the sensor 309 may have passed through a corresponding spectral filter and microlens, but may also have passed through a spectral filter and a microlens that do not correspond to each other. Two such rays are shown in a first highlighted area 312. Also, a ray that strikes the sensing surface of the sensor 309 may not strike the microlens-image area 313 that corresponds to a corresponding spectral filter and microlens. Two such rays are shown in a second highlighted area 314.

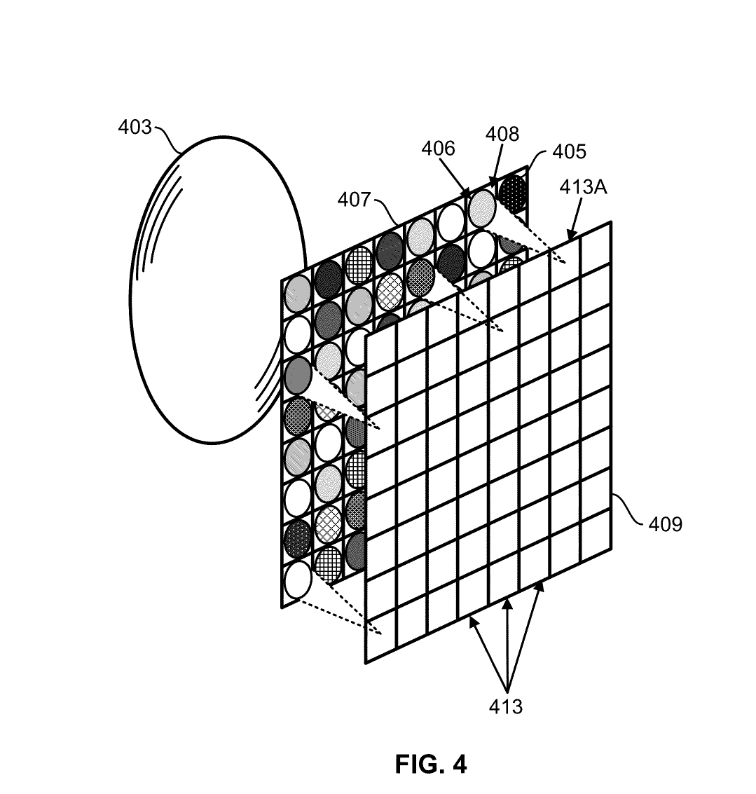

FIG. 4 illustrates an example embodiment of a configuration of a main lens 4003, a microlens array 405, a multispectral-filter array 407, and a sensor 409. Light rays pass through the main lens 403, through the microlens array 405, and through the multispectral-filter array 407 as they travel to the sensor 409. In this embodiment, the multispectral-filter array 407 and the microlens array 405 are immediately adjacent to each other or are integrated together.

The sensor 409 is organized into a plurality of microlens-image areas 413. The light rays that pass through a microlens in the microlens array 405 and the corresponding spectral filter in the multispectral-filter array 407 are detected by a corresponding microlens-image area 413 of the sensor 409. For example, the light rays that pass through a first microlens 406 and the corresponding spectral filter 408 of the multispectral-filter array 407 are detected by a first microlens-image area 413A. Therefore, each microlens-image area 413 may capture an image of different parts of a scene. Accordingly, the example configuration that is shown in FIG. 4 can generate sixty-four microlens images of a scene.

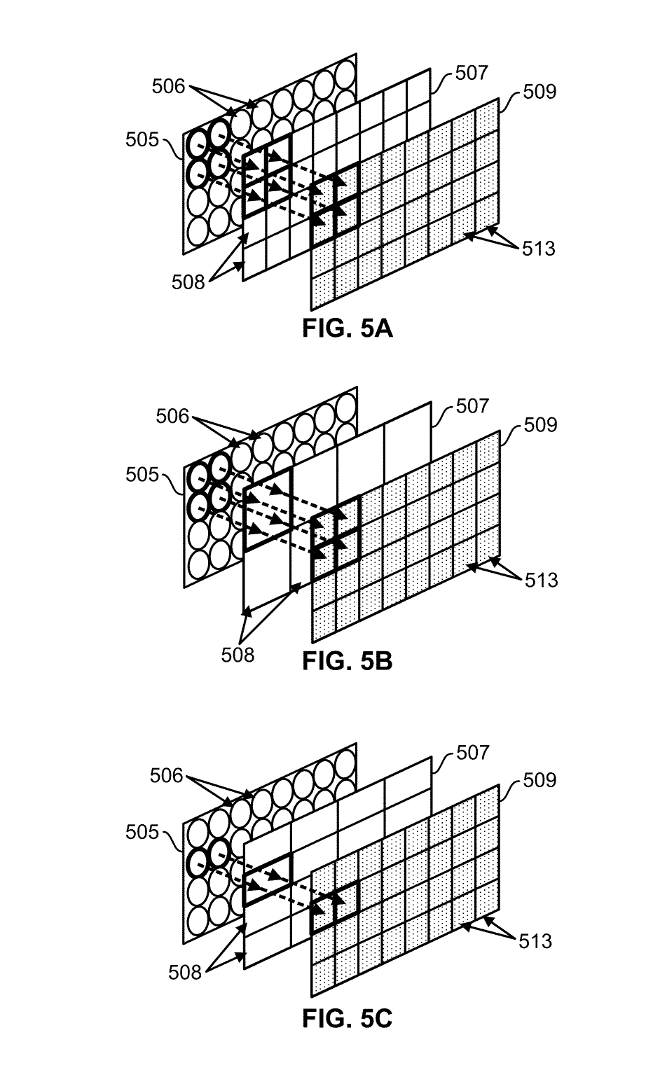

FIG. 5A illustrates an example embodiment of a microlens array 505, a multispectral-filter array 507, and a sensor 509. In this embodiment, each microlens 506 in the microlens array 505 is aligned with a corresponding spectral filter 508 in the multispectral-filter array 507. Light that passes through a microlens 506 also passes through the corresponding spectral filter 508 as the light travels to the sensing surface of a corresponding microlens-image area 513 of the sensor 509. Thus, in this embodiment, the ratio of microlenses to spectral filters is 1:1.

FIG. 5B illustrates an example embodiment of a microlens array 505, a multispectral-filter array 507, and a sensor 509. In this embodiment, four microlenses 506 in the microlens array 505 are aligned with one corresponding spectral filter 508 in the multispectral-filter array 507. Light that passes through the four microlenses 506 that are aligned with a spectral filter 508 also passes through the spectral filter 508 as the light travels to the sensing surface of a corresponding microlens-image area 513 of the sensor 509. Thus, in this embodiment, the ratio of microlenses 506 to spectral filters 508 is 4:1. Also, a single spectral filter may be the corresponding spectral filter of more than one corresponding spectral filter and microlens.

However, although the light from four microlenses 506 can travel through the same spectral filter 508, each microlens still has a unique microlens-image area 513. Accordingly, the ratio of microlenses 506 to microlens-image areas 513 is 1:1.

FIG. 5C illustrates an example embodiment of a microlens array 505, a multispectral-filter array 507, and a sensor 509. In this embodiment, two microlenses 506 in the microlens array 505 are aligned with one corresponding spectral filter 508 in the multispectral-filter array 507. Light that passes through the two microlenses 506 that are aligned with a spectral filter 508 also passes through the spectral filter 508 as the light travels to the sensing surface of the sensor 509. Thus, in this embodiment, the ratio of microlenses 506 to spectral filters 508 is 2:1. However, like FIG. 5B, although the light from two microlenses 506 can travel through the same spectral filter 508, each microlens still has a unique microlens-image area 513. Therefore, the ratio of microlenses 506 to microlens-image areas 513 is 1:1.

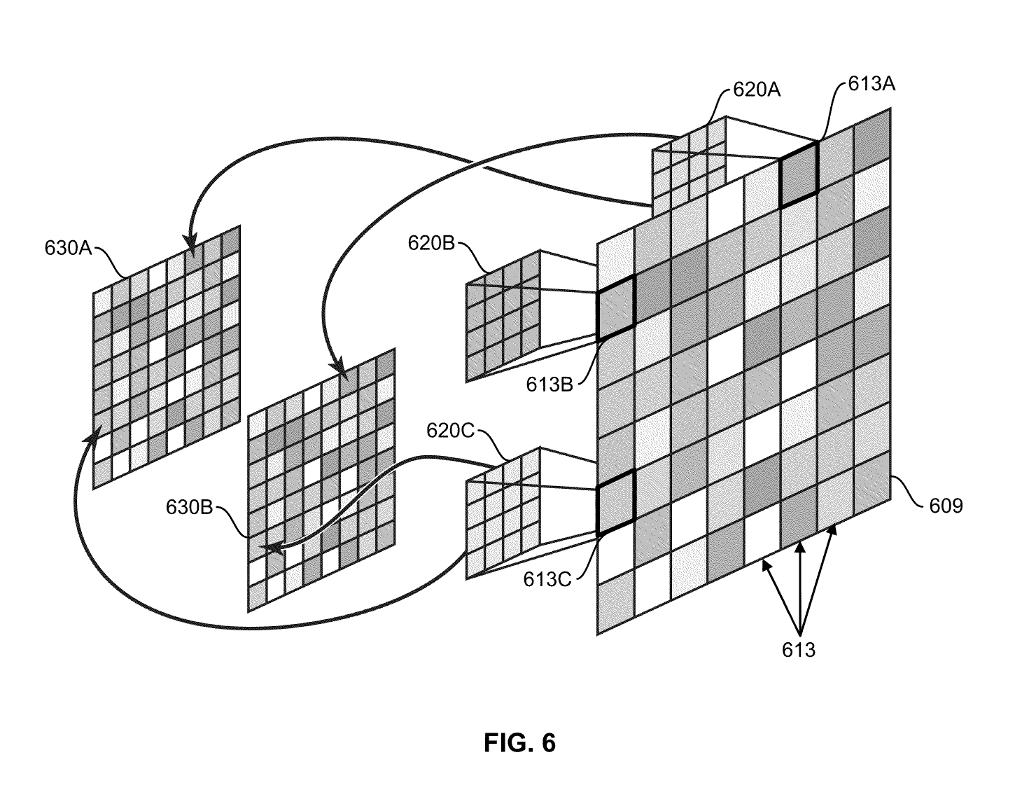

FIG. 6 illustrates example embodiments of a sensor 609, microlens images 620, and sub-aperture images 630. The sensor 609 includes a plurality of microlens-image areas 613, including a first microlens-image area 613A, a second microlens-image area 613B, and a third microlens-image area 613C. Each microlens image 620 is an image that was captured by a corresponding microlens-image area 613. FIG. 6 illustrates three microlens images 620: a first microlens image 620A that was captured by the first microlens-image area 613A, a second microlens image 620B that was captured by the second microlens-image area 613B, and a third microlens image 620C that was captured by the third microlens-image area 613C. In this example, each microlens image 620 includes sixteen pixels, and each microlens-image area 613 of the sensor 609 includes sixteen pixels (the individual pixels of the sensor 609 are not illustrated in FIG. 6).

Also, FIG. 6 illustrates two sub-aperture images 630: a first sub-aperture image 630A and a second sub-aperture image 630B. Each sub-aperture image 630 includes a pixel from each microlens image 620. In this embodiment, a pixel from a microlens image 620 is assigned to a position in a sub-aperture image 630 that corresponds to the position in the sensor 609 of the microlens-image area 613 that includes the pixel. Furthermore, in this embodiment, a pixel from each microlens image 620 is assigned to each sub-aperture image 630. Therefore, in FIG. 6, each of the squares in the sub-aperture images 630 and in the microlens images 620 depicts one pixel, while each of the squares of the sensor 609 depicts one microlens image 620. Also, each sub-aperture image 630 depicts the scene from a different perspective.

For example, consider a camera with an N×N microlens array and a sensor 609 that has a sensor size S×S, where the size S×S is defined by the number of pixels in the sensor 609. The size of each microlens image 620, which is defined by the number of pixels of the microlens image 620, is therefore L×L, where L=[S/N]. Thus, in the example illustrated in FIG. 6, N=8, S=32, and L=4. By forming sub-aperture images 630, an array of L×L sub-aperture images 630, which sample the scene with viewpoint variations, is obtained. The resolution of each sub-aperture image 630 equals the number of microlenses of the microlens array. Thus the resolution of each sub-aperture image 630 in FIG. 6 is N×N.

Accordingly, in the embodiment shown in FIG. 6, the total number of squares of the sensor 609 equals the number of microlenses of a corresponding microlens array, which may be the same as the number of filters in the corresponding multispectral-filter array. Also, although FIG. 6 specifically illustrates the first microlens image 620A, the second microlens image 620B, and the third microlens image 620C, the total number of microlens images 620 that are generated by the sensor 609 is N×N. By taking a pixel from each microlens image (the total number of microlens images is N×N, each with a resolution of L×L), some embodiments form L×L sub-aperture images, each of which has a resolution of N×N.

Furthermore, because each microlens is aligned with a corresponding spectral filter, each microlens image 620 samples one spectral band. In contrast, the sub-aperture images 630 have pixels from different spectral bands, and the distribution of the spectral bands is the same as the distribution of the multispectral-filter array that was used to capture the image on the sensor 609.

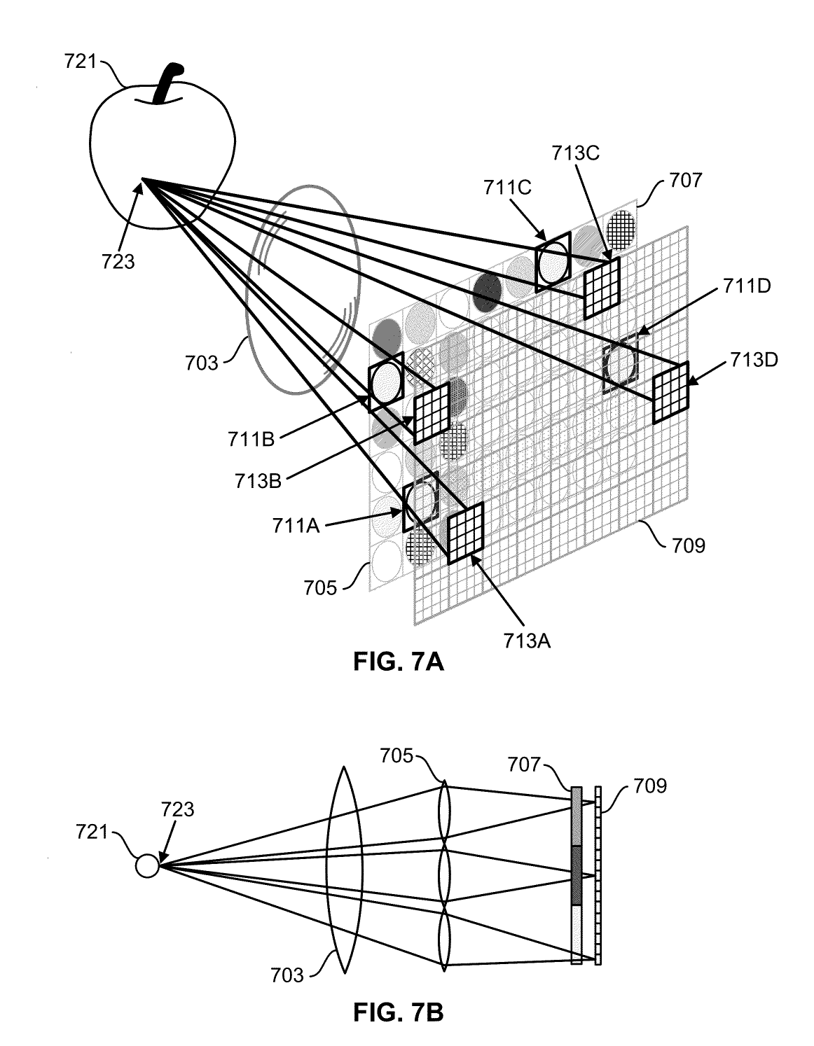

FIG. 7A illustrates an example embodiment of an object 721, a main lens 703, a microlens array 705, a multispectral-filter array 707, and a sensor 709. Light rays from a point 723 on the surface of the object 721 pass through the main lens 703 to the microlens array 705 and the multispectral-filter array 707. The light rays then reach the sensing surface of the sensor 709. Because the light rays pass through the different spectral filters in the multispectral-filter array 707 as the light rays travel the different paths from the point 723 on the surface of the object 721 to the microlens-image areas 713 of the sensor 709, the sensor 709 acquires multiple spectral samples of the point 723 on the object 721.

For example, light rays from the point 723 pass through the main lens 703 and a first corresponding spectral filter and microlens 711A to a first microlens-image area 713A, and light rays from the point 723 pass through the main lens 703 and a second corresponding spectral filter and microlens 711B to a second microlens-image area 713B. Also, light rays from the point 723 pass through the main lens 703 and a third corresponding spectral filter and microlens 711C to a third microlens-image area 713C, and light rays from the point 723 pass through the main lens 703 and a fourth corresponding spectral filter and microlens 711D to a fourth microlens-image area 713D. Thus, if the spectral filters of the first, second, third, and fourth corresponding spectral filters and microlenses 711A-D are different from each other, the sensor 709 acquires multiple spectral samples of the point 723 on the surface of the object 721.

FIG. 7B illustrates an example embodiment of an object 721, a main lens 703, a microlens array 705, a multispectral-filter array 707, and a sensor 709. Light from a point 723 on the surface of the object 721 passes through the main lens 703, through the microlens array 705, and through the multispectral-filter array 707. The light then reaches the sensor 709. Because the light from the point 723 passes through the different spectral filters of the multispectral-filter array 707 as the light travels to the sensor 709, the sensor 709 acquires multiple spectral samples of the point 723 on the object 721.

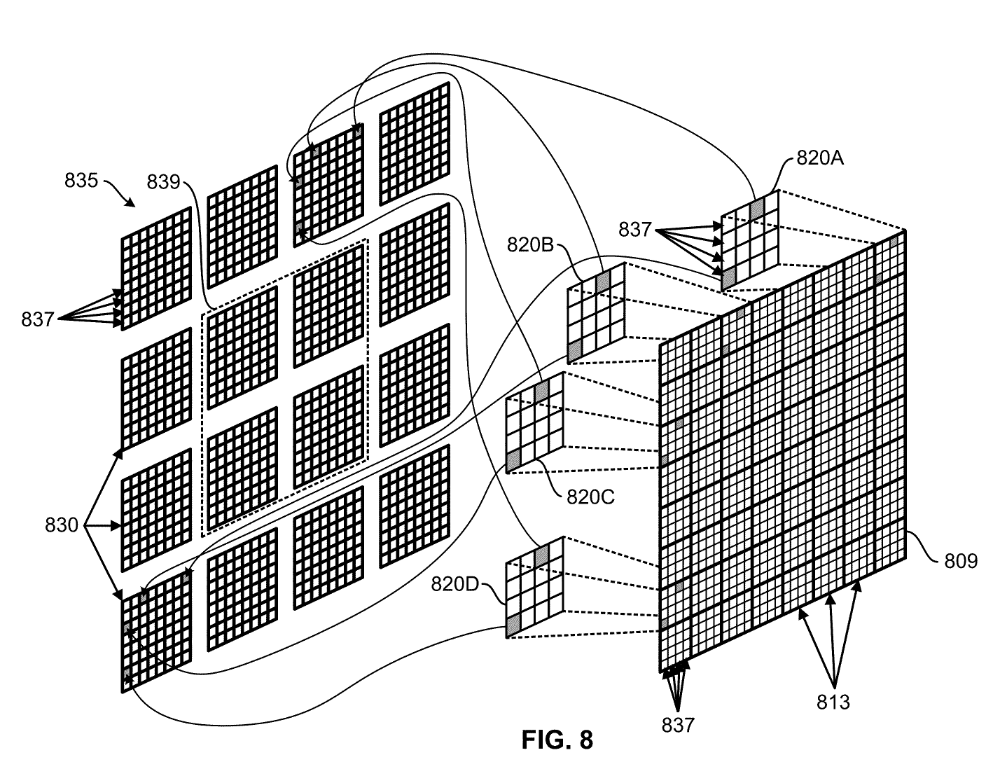

FIG. 8 illustrates example embodiments of a sensor 809, microlens images 820, and an array of sub-aperture images 830. The sensor 809 includes a plurality of microlens-image areas 813, each of which captures a respective microlens image 820. The microlens images 820 include a first microlens image 820A, a second microlens image 820B, a third microlens image 820C, and a fourth microlens image 820D. The microlens images 820 are resampled to generate a sub-aperture-image array 835, which includes a plurality of sub-aperture images 830.

In this embodiment, each sub-aperture image 830 includes a pixel 837 from each microlens image 820. Also, the position of a pixel 837 in a sub-aperture image 830 is the same as the position of the microlens-image area 813 that captured the pixel 837 in the sensor 809. Eight pixels 837 in FIG. 8 are shaded to further illustrate the relationships of the positions of the pixels 837 in the sensor 809, in the microlens images 820, and in the sub-aperture images 830.

Furthermore, a sub-aperture image 830 can be selected as the center view. In embodiments where the sub-aperture-image array 835 includes an odd number of rows of sub-aperture images 830 and an odd number of columns of sub-aperture images 830, the sub-aperture image 830 in the center of the sub-aperture-image array 835 can be selected as the center view.

However, if the sub-aperture-image array 835 has an even number of rows of sub-aperture images 830 or an even number of columns of sub-aperture images 830, then a sub-aperture image 830 that is adjacent to the center of the sub-aperture-image array 835 can be selected as the center view. For example, the sub-aperture-image array 835 in FIG. 8 includes an even number of rows of sub-aperture images 830 and an even number of columns of sub-aperture images 830. Thus, any of the four sub-aperture images 830 in the center area 839 could be selected as the center view.

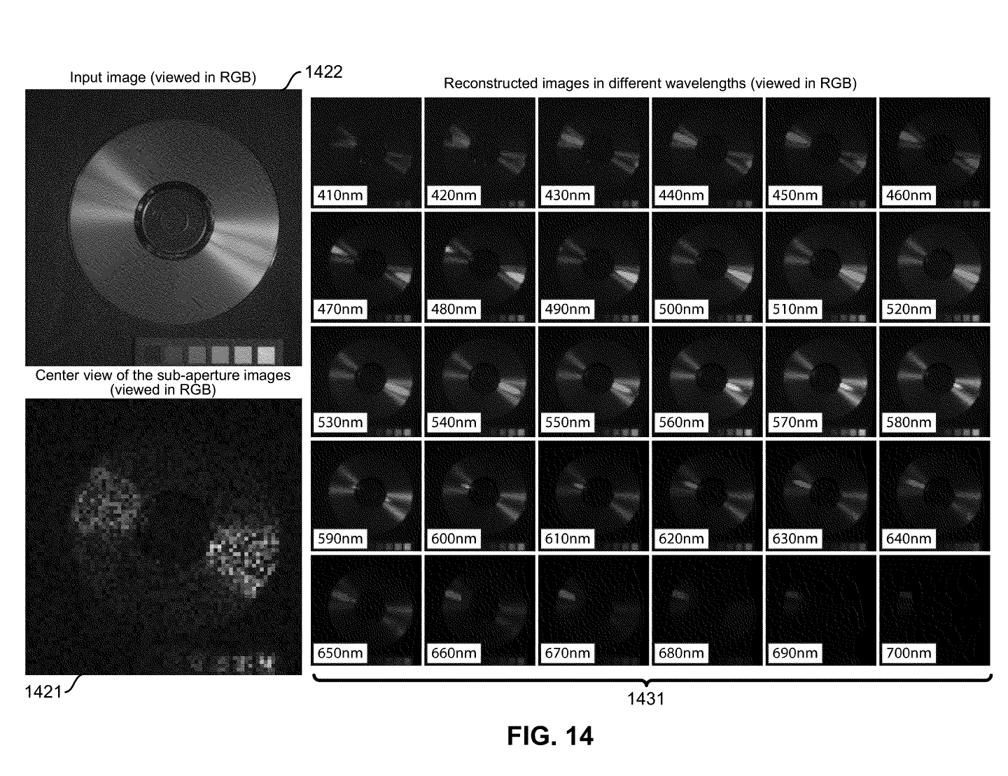

Also, in some embodiments, one or more of the other sub-aperture images 830 are used as the center view. In some embodiments, such as embodiments that reconstruct the entire light field (e.g., as explained in the description of FIG. 14), each of the sub-aperture images is used as the center view during reconstruction.

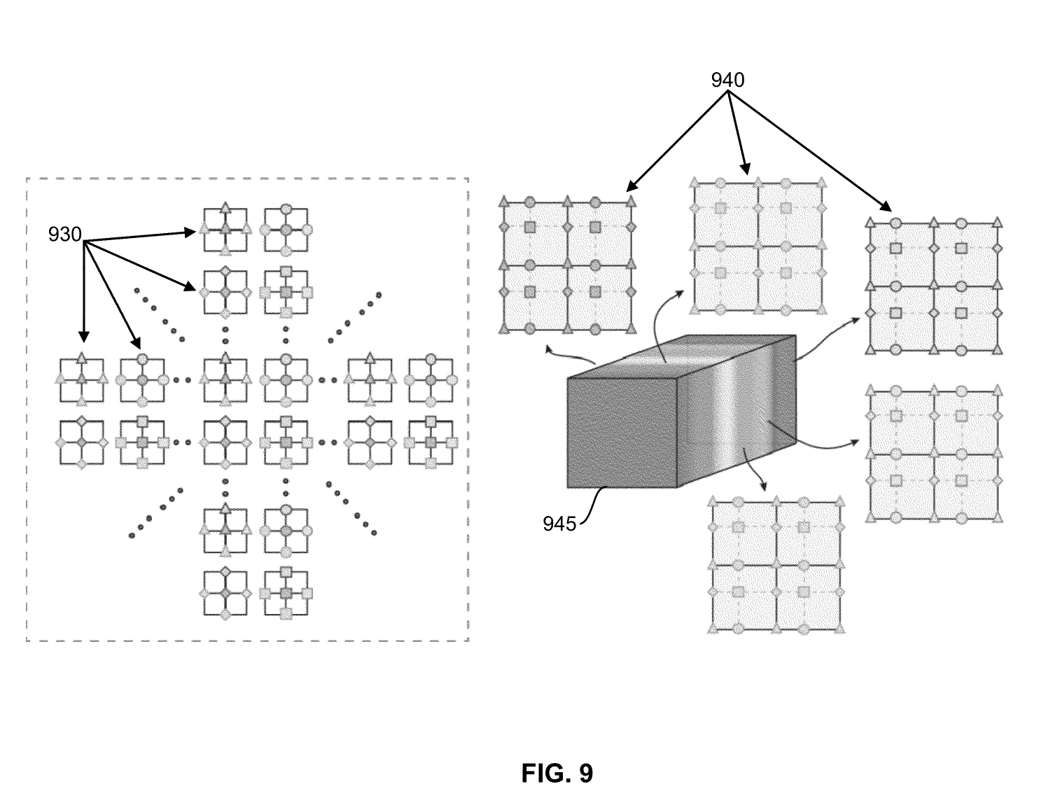

FIG. 9 illustrates an example embodiment of image formation from multispectral sub-aperture images. The triangle, square, circle, and diamond-shaped symbols in FIG. 9 represent pixels from different sub-aperture images 930. Higher-resolution images 940 can be generated by mapping the lower-resolution sub-aperture images 930 to a uniform coordinate system using the pixel shifts, which are shown as distances between different-shaped pixels in the higher-resolution images 940. In this example, the higher-resolution images 940 are depicted as a hyperspectral data cube 945 (i.e., an image stack).

Given an array of spectrally-coded lower-resolution (N×N resolution) sub-aperture images Y_{LF} 930, embodiments of the systems, devices, and methods that are described herein reconstruct one or more higher-resolution multispectral (HR-MS) images x 940. Assuming that the super-resolved resolution of the HR-MS images x 940 is M×M (in one example embodiment, M≈N×3), and assuming that k spectral bands (k equals the number of spectral bands in the multispectral-filter array) are recovered, the dimensionality of the collection of HR-MS images x 940 (e.g., the hyperspectral data cube 945) is M×M×k.

Also, in some embodiments the HR-MS images x 940 correspond to the respective center views of the sub-aperture images Y_{LF} 930. To extend the HR-MS images x 940 to all views of the sub-aperture images Y_{LF} 930, some embodiments first estimate the depth of the scene (“scene depth”) depicted by the images in the hyperspectral data cube 945. The scene depth may be calculated from the sub-aperture images or from other information (e.g., information that was obtained from a stereo camera). Also, the scene depth may be assumed to be a known input. In some embodiments, the scene is assumed to be far away from the camera, and the objects in the scene are assumed to have the same depth (for example, when the scene is viewed from an aircraft). Given the baseline of the microlens array, the depth values can be converted to disparities (e.g., sub-pixel shifts) among the sub-aperture images Y_{LF} 930. Additionally, given the disparity d_{i,j}=[dᵢ, dⱼ], where dᵢ refers to the horizontal disparity and dⱼ refers to the vertical disparity, between the (i,j)th sub-aperture image Y_{LF} 930 and the center view sub-aperture image Y_{LF} 930 in the sub-aperture-image array, some embodiments form a warping matrix t(d_{i,j}) to translate the center view to the (i,j)th sub-aperture image based on d_{i,j}. The warping matrix t(d_{i,j}) is dependent on the distance of the point in the scene (e.g., a point on an object in the scene) to the camera. Also, for neighboring views, the disparity d_{i,j} may be described in sub-pixels. For views with large gaps, for example the left-most and the right-most sub-aperture images in the same row, the disparity may be greater than one pixel.

Applying the warping matrix t(d_{i,j}) to the center view maps pixel p in the center view to pixel q in (i,j)th sub-aperture image such that

q=p+[dᵢ,dⱼ]. (1)

Using this warping technique, some embodiments extend the HR-MS images x 940 to the full light field, with viewpoint variations.

Additionally, some embodiments derive the relationships between the latent HR-MS images x 940 and the multispectral sub-aperture images Y_{LF} 930 captured by a camera. The HR-MS images x 940 form a stack of high-resolution (HR) images of different spectral bands (for example, the thirty spectral bands in the embodiment of FIG. 9). To derive the relationships, some embodiments first apply the warping matrix t(d_{i,j}) to the HR-MS images x 940 that correspond to the respective center view of the sub-aperture images Y_{LF} 930 in order to map the HR-MS images x 940 to other sub-aperture images Y_{LF} 930 in the light field. Then the warped images are down-sampled by a scaling factor g=M/N. The down sampling may be modeled by a down-sample matrix b_{N}^{M}. In some embodiments, the down-sample matrix b_{N}^{M} is formed using a Gaussian function. Finally, a spectral-mask filter w is applied to project the HR-MS images x 940 from N×N×k to N×N. In some embodiments, all of the sub-aperture images Y_{LF} 930 have the same spectral-filter distribution. Therefore, in these embodiments the spectral-mask filter w, which is determined by the multispectral-filter array that is applied to the microlens array, is identical for all images.

Based on these techniques, the (i, j)th sub-aperture image y_{i,j} can be calculated according to

y_{i,j}=wb_{N}^{M}t(d_{i,j})x+n_{i,j}, (2)

where n_{i,j} is the Gaussian noise GN that is introduced in the imaging process, where t(d_{i,j}) is the warping matrix, where d_{i,j} is the distance between the (i,j)th sub-aperture image and the center view, where w is the spectral-mask filter (which is based on the multispectral-filter array), and where b_{N}^{M} is the down-sample matrix, which downsamples the resolution from M to N.

Some embodiments stack all L×L sub-aperture images {y_{i,j}|0≦i≦L−1, 0≦j≦L−1} and calculate the relationships between the sub-aperture images Y_{LF} and the HR-MS images x according to

Y_{LF}=WB_{N}^{M}Tx+GN, (3)

where

$${Y}_{LF} = [ \begin{matrix}{y}_{0 , 0} \\ {y}_{0 , 1} \\ ⋮ \\ {y}_{L - 1 , L - 1}\end{matrix} ] , W = [ \begin{matrix}w & & & \\ & w & & \\ & & ⋱ & \\ & & & w\end{matrix} ] , {B}_{N}^{M} = [ \begin{matrix}{b}_{N}^{M} & & & \\ & {b}_{N}^{M} & & \\ & & ⋱ & \\ & & & {b}_{N}^{M}\end{matrix} ] , T = [ \begin{matrix}t ( {d}_{0 , 0} ) \\ t ( {d}_{0 , 1} ) \\ ⋮ \\ t ( {d}_{L - 1 , L - 1} )\end{matrix} ] , and GN = [ \begin{matrix}{n}_{0 , 0} \\ {n}_{0 , 1} \\ ⋮ \\ {n}_{L - 1 , L - 1}\end{matrix} ] .$$

Equation (3) can be further simplified to

Y_{LF}Ax+GN, (4)

where

A=[wb_{N}^{M}t(d_{0,0}); wb_{N}^{M}t(d_{0,1}); . . . ; wb_{N}^{M}t(d_{i,j}); . . . ].

A brute-force approach to solve x in equation (4) uses the classical pseudo inverse, which takes the derivative of x and sets it to zero:

A^{T}(GN−Ax)=0. (5)

However, the singularity in A^{T}A makes the problem ill-posed, because an infinite number of solutions exists due to the null space in A.

To make this problem tractable, additional image priors can be taken into consideration. First, some embodiments use the spatial sparsity prior for natural images. The spatial sparsity prior indicates that the gradients of natural images are sparse, and therefore most gradient values are zero or, due to image noise, close to zero.

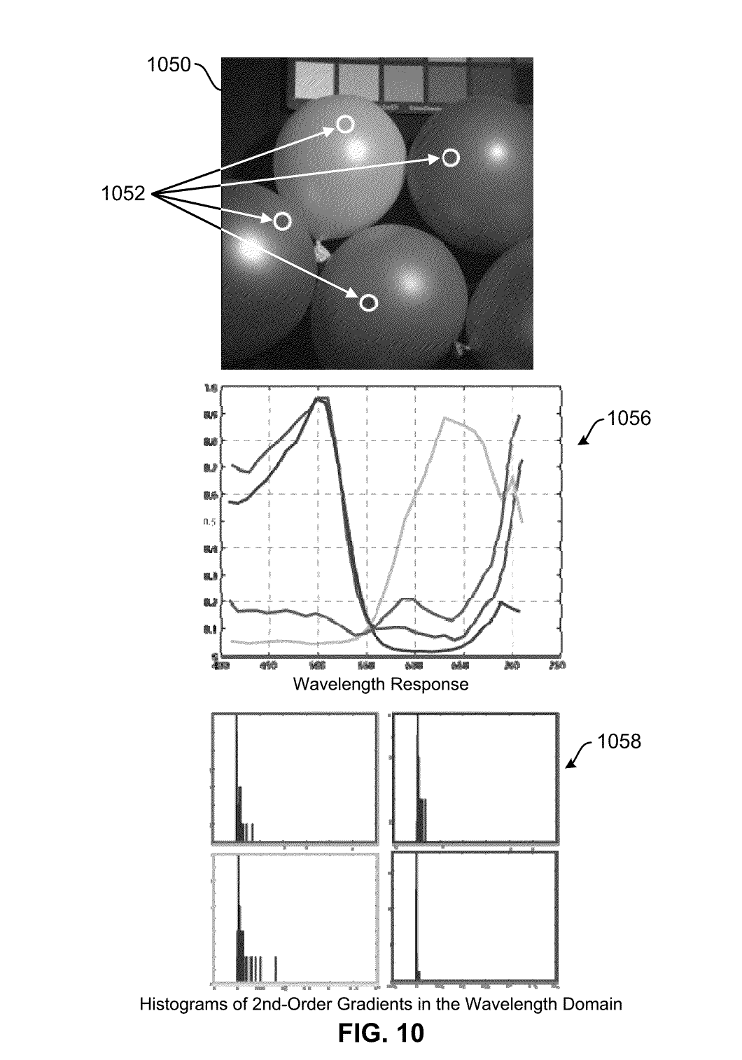

Furthermore, for multispectral images, the second-order gradients in the wavelength domain may be sparse, and thus most elements are zero. FIG. 10 illustrates example embodiments of a multispectral image 1050, the wavelength responses 1056 of four pixels 1052 in the multispectral image 1050, and the histograms of the second-order gradients 1058 of the four pixels 1052. The image 1050 is from the Columbia Multi-spectral Image Dataset. As shown in the second-order gradient histogram 1058, a majority of the second-order gradients are equal or close to zero, which indicates the sparsity of the second-order gradients in the wavelength domain.

By integrating the gradient-sparsity prior in the spatial domain and the second-order gradient-sparsity prior in the wavelength domain, the objective function for optimizing the HR-MS image x in equation (4) can be calculated according to

$$x = {arg min}_{x} \{ \underbrace{{‖ {Y}_{LF} - Ax ‖}_{2}}_{1} + γ \underbrace{{‖ {∇}_{x , y} x ‖}_{1}}_{2} + λ \underbrace{{‖ {∇}_{w}^{2} x ‖}_{1}}_{3} \} , \\ subject to 0 \leq x \leq 1 \qquad ( 6 )$$

where γ and λ are regularization parameters, where ∇_{x,y} is the gradient operator in the spatial domain

$$( e . g . , {∇}_{x , y} = \vert \frac{\partial x}{\partial x} \vert + \vert \frac{\partial x}{\partial y} \vert ) ,$$

where ∇_{w}² is the second-order differential operator in the wavelength domain

$$( e . g . , {∇}_{w}^{2} = \frac{{\partial }^{2} x}{\partial {w}^{2}} ) ,$$

and where w refers to the wavelength. Term 1 of equation (6) is the least square optimization for x, term 2 is the spatial-gradient sparsity prior in the HR-MS image x, and term 3 is the second-order-gradient sparsity prior in the wavelength domain in the HR-MS image x.

The HR-MS image x can be generated by minimizing the objective function of equation (6) using a standard optimization framework. For example, some embodiments use infeasible path-following algorithms.

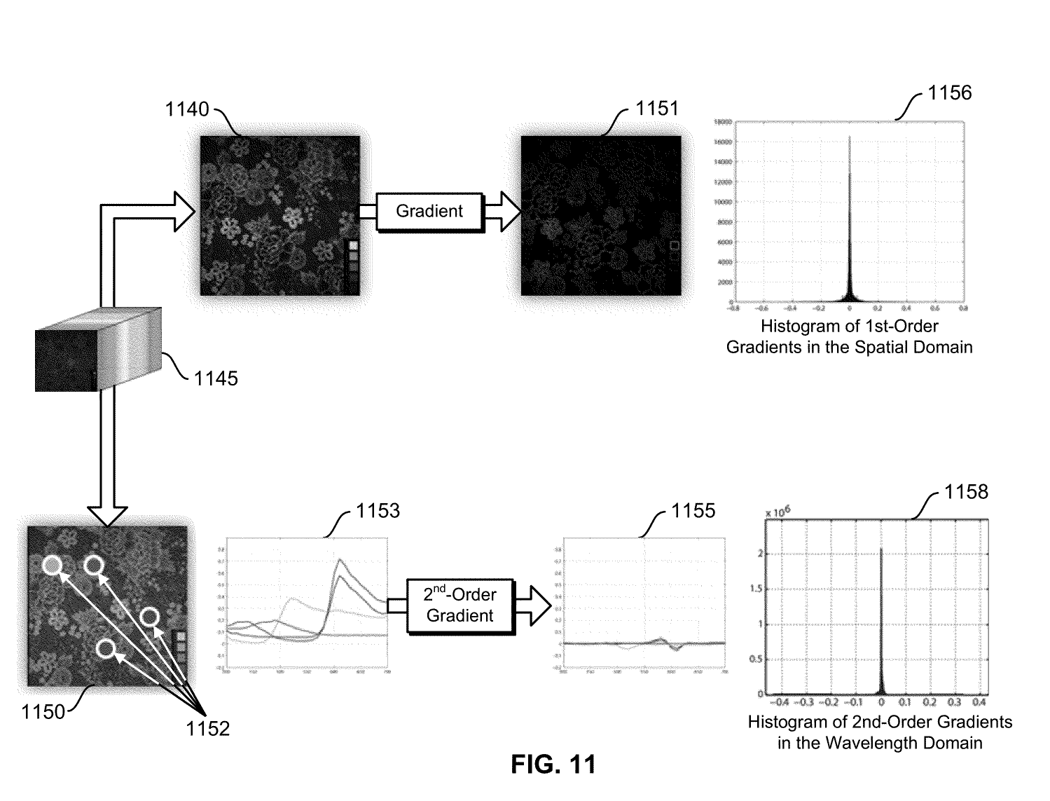

FIG. 11 illustrates example embodiments of first-order gradients in the spatial domain and second-order gradients in the wavelength domain. FIG. 11 shows a histogram 1156 of the first-order gradients in the spatial domain 1151 of all of the pixels in an image 1140 that is from a hyperspectral data cube 1145. FIG. 11 also shows a histogram 1158 of the second-order gradients in the wavelength domain of an image 1150 that is from a hyperspectral data cube 1145. Additionally, chart 1153 plots the distribution of first order gradients of four pixels 1152 in the image 1150, and chart 1155 plots the distribution of second order gradients of the four pixels 1152 in the image 1150.

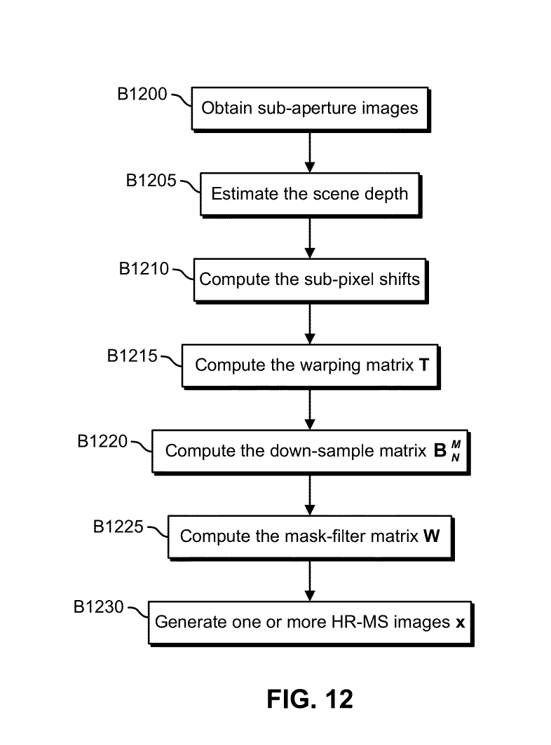

FIG. 12 illustrates an example embodiment of an operational flow for image reconstruction. The blocks of this operational flow and the other operational flows that are described herein may be performed by one or more computing devices, for example the computing devices that are described herein. Also, although this operational flow and the other operational flows that are described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this operational flow and the other operational flows that are described herein may omit blocks, add blocks, change the order of the blocks, combine blocks, or divide blocks into more blocks.

The flow starts in block B1200, where sub-aperture images are obtained. Next, in block B1205, the scene depth is estimated (e.g. from the sub-aperture images). The flow then moves to block B1210, where the pixel shifts (which may be sub-pixel shifts if the disparities are less than a pixel) are computed for each of the sub-aperture images. Then, in block B1215, the warping matrix T is computed based on the sub-pixel shifts. In block B1220, the down-sample matrix B_{N}^{M} is computed. The down-sample matrix B_{N}^{M} can be adjusted, although it may have limits that depend on the size of the microlenses and the scene depth. In block B1225, the mask-filter matrix W is computed, for example based on the multispectral-filter array that was used to capture the sub-aperture images. Finally, in block B1230, the HR-MS images x are generated, for example according to equation (6).

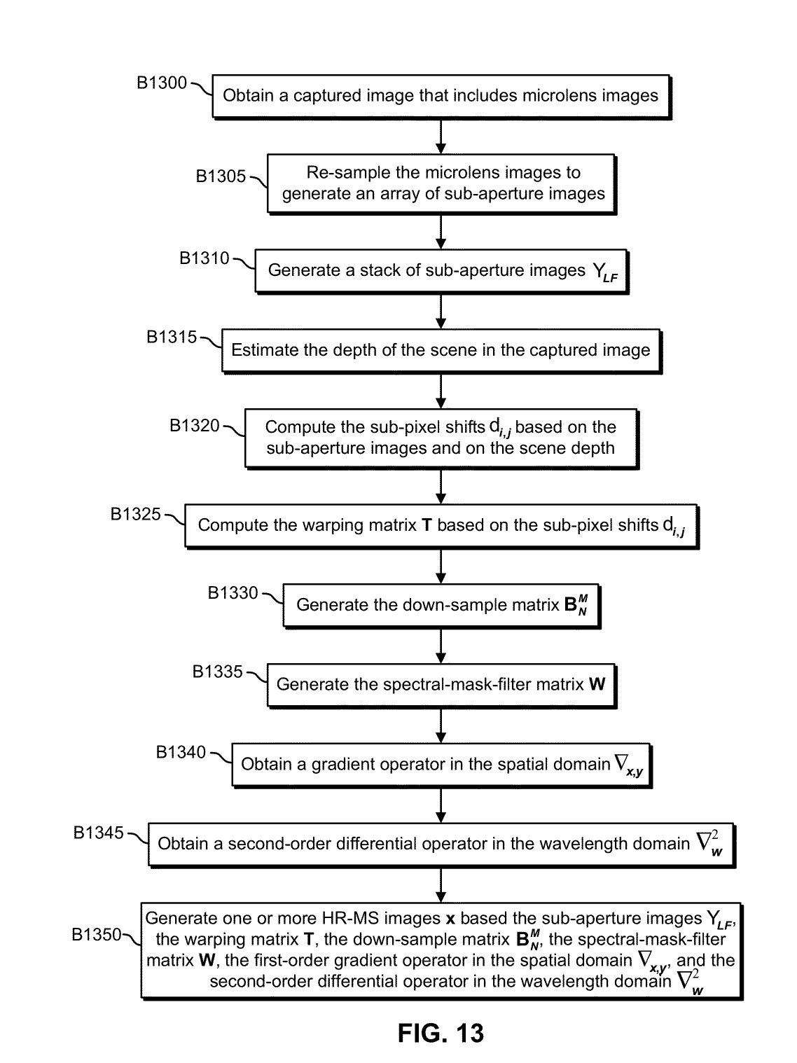

FIG. 13 illustrates an example embodiment of an operational flow for generating high-resolution multispectral images. The flow starts in block B1300, where an image of the scene is obtained. The image was captured using a multispectral light-field camera, which has a microlens array and a multispectral-filter array. Due to the use of the microlens array and multispectral-filter array, the captured image is composed of a plurality of microlens images, and the microlens images depict different spectrums. The spectrum that is depicted by a microlens image is determined by the microlens and the corresponding spectral filter that were used to capture the microlens image.

Then, in block B1305, the image, which includes the microlens images, is resampled to generate a plurality of sub-aperture images, for example as explained in the description of FIG. 6 or FIG. 8. The flow then moves to block B1310, where the sub-aperture images are arranged to form a stack Y_{LF} or a row vector Y_{LF}. Next, in block B1315, the depth of the scene in the captured image is estimated using at least some of the sub-aperture images or using the obtained image. The flow then proceeds to block B1320, where the sub-pixel shifts d_{i,j} are computed based on the scene depth and on the sub-aperture images. The flow then moves to block B1325, where the warping matrix T is computed based on the sub-pixel shifts d_{i,j}.

Next, in block B1330, a down-sample matrix B_{N}^{M} is generated based on a resolution ratio. In some embodiments, a Gaussian down-sample method is used. Also, the resolution ratio may be calculated based on the sub-pixel shifts in neighboring sub-aperture images. For example, if the sub-aperture shift is ⅓ pixel for a scene point in two adjacent sub-aperture images, then the maximum resolution ratio M/N is 3.

Then in block B1335, a spectral-mask-filter matrix W is generated, for example according to the multispectral-filter array used in the multispectral light field camera that captured the image of the scene. The flow then moves to block B1340, where a matrix for computing a first-order gradient operator in the spatial domain ∇_{x,y} is obtained. Next, in block 1345, a matrix for computing the second-order differential operator in the wavelength domain ∇_{w}² is formed.

Finally, in block B1350, the stack of sub-aperture images Y_{LF}, the warping matrix T, the down-sample matrix B_{N}^{M}, the spectral mask-filter matrix W, the first-order gradient operator in the spatial domain ∇_{x,y}, and the second-order differential operator in the wavelength domain ∇_{w}² are used to generate one or more high-resolution multispectral images x, for example according to one or more of equations (3), (4), and (6).

Accordingly, in some embodiments, an optimization algorithm for reconstructing high-resolution multispectral images exploits the sub-pixel shift in light-field sub-aperture images and the sparsity prior in the second-order gradients of spectral images in the wavelength domain.

Also, to analyze the noise sensitivity, some embodiments add various levels of Gaussian noise to the input scene and then perform reconstruction. The Peak Signal-Noise Ratio (PSNR) and the Root Mean Square Error (RMSE) of the reconstructed images with respect to different noise levels are listed in Table 1.

TABLE 1

| Noise Level | 0% | 1% | 5% | 10% |
|---|---|---|---|---|
| PSNR | 42.4655 | 28.7958 | 24.1607 | 17.4221 |
| RMSE | 0.0077 | 0.0373 | 0.0619 | 0.1345 |

FIG. 14 illustrates an example embodiment of a high-resolution multispectral image. As an input light-field image, this example used an image from the Columbia Multispectral Image Dataset. The original resolution of the input image was 512×512. For illustrative purposes, FIG. 14 shows a standard RGB representation 1422 of the input image. To reduce computational time and memory usage, this example down-sampled the image resolution to 216×216. Also, this embodiment used visible spectral bands ranging from 410 nm to 700 nm with steps of 10 nm, for a total of 30 spectral bands. When synthesizing the input light-field image, which was captured by a spectrally-coded light-field camera, the scene was assumed to be 10 m away from the camera. Ray tracing was used to render 72×72 microlens images, each of which had a resolution of 9×9. The microlens images were resampled to a 9×9 sub-aperture-image array (81 total sub-aperture images), and each sub-aperture image had a resolution of 72×72. FIG. 14 shows the center view 1421 of the sub-aperture images.

Also, the light-field camera was assumed to be pre-calibrated, which gave the baseline for computing sub-pixel shifts for the sub-aperture images based on the scene depth. Then this example computed the warping matrix T according to equation (1) and computed the down-sample matrix B_{N}^{M} using a Gaussian filter with the scaling factor g=3. To estimate the HR-MS images x, this embodiment solved the optimization problem by minimizing the objective function that is described by equation (6).

The reconstruction result is shown in FIG. 14, which shows thirty reconstructed images 1431. Each of the reconstructed images 1431 has a resolution of 216×216, which is three times greater than the original sub-aperture image resolution (72×72) in the horizontal direction and three times greater in the vertical direction.

Thus, from one image capture, the system generated 72×72 microlens images (each having a resolution of 9×9), and from the microlens images the system generated thirty reconstructed images 1431 (each having a resolution of 216×216), and the thirty reconstructed images 1431 compose an HR-MS image x.

Also, each of the thirty reconstructed images 1431 is an image of a different spectral band. To reconstruct the entire light field, an HR-MS image x can be reconstructed for each sub-aperture image by using a warping matrix T with pixel shifts that are based on the corresponding sub-aperture image as the center view. Therefore, thirty reconstructed images can be generated while using each of the 9×9 sub-aperture images as the center view, for a total of 81×30 images. Accordingly, the entire light field can be reconstructed for the captured spectral bands by generating 81 respective HR-MS images x, each of which was generated using a different sub-aperture image as the center view, for a spectral band.

Therefore, compared to existing multispectral light-field cameras, some embodiments can achieve higher spectral resolution (e.g., 30 spectral bands versus 16 spectral bands). And by applying the super-resolution reconstruction algorithm, some embodiments can obtain multispectral images with higher spatial resolution (e.g., 3 times greater).

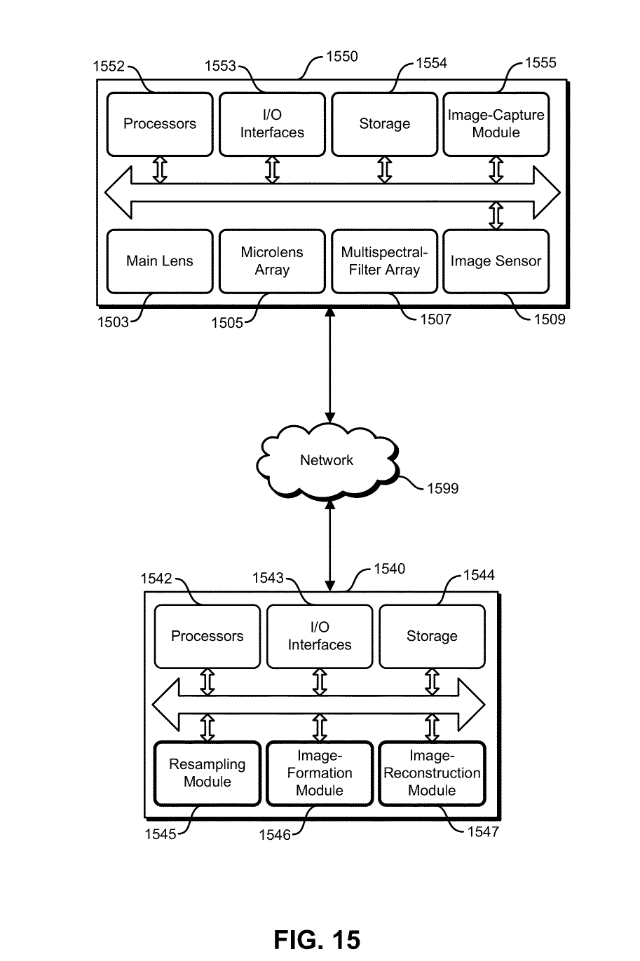

FIG. 15 illustrates an example embodiment of a system for single-shot high-resolution multispectral-image acquisition. The system includes an image-generation device 1540 and a light-field camera 1550. In this embodiment, the devices communicate by means of one or more networks 1599, which may include a wired network, a wireless network, a LAN, a WAN, a MAN, and a PAN. Also, in some embodiments the devices communicate by means of other wired or wireless channels.

The image-generation device 1540 includes one or more processors 1542, one or more I/O interfaces 1543, and storage 1544. Also, the hardware components of the image-generation device 1540 communicate by means of one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 1542 include one or more central processing units (CPUs), which include microprocessors (e.g., a single core microprocessor, a multi-core microprocessor), or other electronic circuitry. The one or more processors 1542 are configured to read and perform computer-executable instructions, such as instructions that are stored in the storage 1544 (e.g., ROM, RAM, a module). The I/O interfaces 1543 include communication interfaces to input and output devices, which may include a keyboard, a display, a mouse, a printing device, a touch screen, a light pen, an optical-storage device, a scanner, a microphone, a camera, a drive, a controller (e.g., a joystick, a control pad), and a network interface controller.

The storage 1544 includes one or more computer-readable storage media. A computer-readable storage medium, in contrast to a mere transitory, propagating signal per se, includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). Also, as used herein, a transitory computer-readable medium refers to a mere transitory, propagating signal per se, and a non-transitory computer-readable medium refers to any computer-readable medium that is not merely a transitory, propagating signal per se. The storage 1544, which may include both ROM and RAM, can store computer-readable data or computer-executable instructions.

The image-generation device 1540 also includes a resampling module 1545, an image-formation module 1546, and an image-reconstruction module 1547. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules. When the modules are implemented in software, the software can be stored in the storage 1544.

The resampling module 1545 includes instructions that, when executed, or circuits that, when activated, cause the image-generation device 1540 to resample microlens images (in captured light-field images) to produce sub-aperture images.

The image-formation module 1546 includes instructions that, when executed, or circuits that, when activated, cause the image-generation device 1540 to estimate the scene depth and compute the sub-pixel shifts for sub-aperture images, compute a warping matrix T, and compute a down-sample matrix B_{N}^{M}.

The image-reconstruction module 1547 includes instructions that, when executed, or circuits that, when activated, cause the image-generation device 1540 to compute a mask-filter matrix W and perform an optimization process to recover one or more HR-MS images x.

The light-field camera 1550 includes one or more processors 1552, one or more I/O interfaces 1553, storage 1554, an image sensor 1509, a main lens 1503, a microlens array 1505, a multispectral-filter array 1507, and an image-capture module 1555. The image-capture module 1555 includes instructions that, when executed, or circuits that, when activated, cause the light-field camera 1550 to capture one or more images using the image sensor 1509, the main lens 1503, the microlens array 1505, and the multispectral-filter array 1507. Furthermore, at least some of the hardware components of the light-field camera 1550 communicate by means of a bus or other electrical connections.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board that is inserted into a device or on a function-extension unit that is connected to the device, and a CPU provided on the function-extension board or unit may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A system comprising:
a main lens;
a microlens array;
a multispectral-filter array that comprises spectral filters that filter light in different wavelengths; and
a sensor that is configured to detect incident light,
wherein the main lens, the microlens array, the multispectral-filter array, and the light sensor are disposed such that light from a scene passes through the main lens, the microlens array, and the multispectral-filter array and strikes a sensing surface of the sensor, and
wherein the multispectral-filter array is disposed so as to encode, in the light that strikes the sensing surface, a plane of the microlens array on the sensing surface of the sensor.

2. The system of claim 1, wherein the main lens is focused on the microlens array.

3. The system of claim 2, wherein the microlens array is focused on the sensor.

4. The system of claim 1, wherein the microlens array is disposed between the main lens and the multispectral-filter array.

5. The system of claim 1, wherein the multispectral-filter array is disposed between the main lens and the microlens array.

6. The system of claim 1, wherein a number of spectral filters in the multispectral-filter array is equal to a number of microlenses in the microlens array.

7. The system of claim 6, wherein each microlens in the microlens array is aligned with a respective corresponding spectral filter of the multispectral-filter array.

8. The system of claim 7, wherein the microlens array and the multispectral-filter array are disposed such that, if a photon travels from the main lens through a microlens to the sensing surface of the sensor, the photon can pass through only the corresponding spectral filter that is aligned with the microlens.

9. The system of claim 7, wherein the microlens array and the multispectral-filter array are disposed such that, between the microlens array and the sensing surface of the sensor, rays of light that pass through a microlens and the corresponding spectral filter do not overlap with rays of light that pass through other microlenses and their corresponding spectral filters.

10. The system of claim 7, wherein all photons that travel through a microlens and the respective spectral filter that is aligned with the microlens strike within a respective microlens-image area on the sensing surface of the sensor.

11. A system comprising:
one or more computer-readable storage media; and
one or more processors that are coupled to the one or more computer-readable storage media and that are configured to cause the system to
obtain a multispectral image that is composed of microlens images, wherein each microlens image was captured by a respective microlens-image area of a sensor, and wherein each microlens image was generated based on light that passed through a main lens, a respective microlens of a microlens array, and a respective spectral filter of a multispectral-filter array and that was detected by the respective microlens-image area of the sensor, and
generate sub-aperture images from the microlens images, wherein a sub-aperture image includes a pixel from each microlens image.

12. The system of claim 11, wherein each microlens image includes L×L pixels, and wherein the one or more processors are further configured to cause the system to generate L×L sub-aperture images.

13. The system of claim 11, wherein, to generate the sub-aperture images from the microlens images, the one or more processors are configured to cause the system to assign a pixel from a microlens image to a position in a sub-aperture image that corresponds to a position of the microlens image in the captured image.

14. The system of claim 11, wherein the captured image includes N×N microlens images, and wherein each sub-aperture image includes N×N pixels.

15. The system of claim 11, wherein the multispectral-filter array includes a first spectral filter that is configured to selectively transmit a first spectrum of light and includes a second spectral filter that is configured to selectively transmit a second spectrum of light that is different from the first spectrum,
wherein one of the microlens images was generated from light that passed through the first spectral filter, and
wherein one of the microlens images was generated from light that passed through the second spectral filter.

16. The system of claim 11, wherein the one or more processors are further configured to cause the system to generate the sub-aperture images from the microlens images based on sub-pixel shifts and spectral filtering according to a downsample operation.

17. The system of claim 16, wherein the sub-pixel shifts are computed using a depth of a scene that is depicted in the multispectral image.

18. The system of claim 16, wherein the spectral filtering uses a multispectral-filter array that is identical to a multispectral-filter array that captured the multispectral image.

19. One or more non-transitory computer-readable media storing instructions that, when executed by one or more computing devices, cause the one or more computing devices to perform operations comprising:
obtaining sub-aperture images; and
generating a higher-resolution multispectral image from the sub-aperture images based on the sub-aperture images and on a sparsity prior in second-order gradients of spectral images in a wavelength domain.

20. The one or more non-transitory computer-readable media of claim 19, wherein generating the higher-resolution multispectral image from the sub-aperture images uses an optimization process.

21. The one or more non-transitory computer-readable media of claim 19, wherein generating the higher-resolution multispectral image from the sub-aperture images is further based on a sparsity prior in first-order gradients of spectral images in an intensity domain.

22. The one or more non-transitory computer-readable media of claim 19,
wherein the sub-aperture images were generated from microlens images,
wherein a sub-aperture image include a pixel from each microlens image,
wherein each microlens image was captured by a respective microlens-image area of a sensor, and
wherein each microlens image was generated based on light that passed through a main lens, a respective microlens of a microlens array, and a respective spectral filter of a multispectral-filter array and that was detected by the respective microlens-image area of the sensor.
